(19) United States
(12) Patent Application Publication
(10) Pub. No.: US 2025/0296893 A1
(43) Pub. Date: Sep. 25, 2025

(54) Efficient Combined Nano Iron Suspension Fertilizer and Preparation Method and Use Thereof

(71) Applicant: Southwest University, Chongqing (CN)

(72) Inventors: Dunyi LIU, Chongqing (CN); Ziwei XU, Chongqing (CN); Lingyun CHEN, Chongqing (CN); Wenhui CHEN, Chongqing (CN); Xinping CHEN, Chongqing (CN)

(73) Assignee: Southwest University, Chongqing (CN)

(21) Appl. No.: 19/087,669

(22) Filed: Mar. 24, 2025

(30) Foreign Application Priority Data
Mar. 25, 2024 (CN) 202410345505.5

(51) Int. Cl. C05D 9/02; C05G 5/27

(52) U.S. Cl. CPC C05D 9/02; C05G 5/27

(57) ABSTRACT

Provided is an efficient combined nano iron suspension fertilizer. The suspension fertilizer efficient combined nano iron is prepared from ingredients including, in mass percentage: 10.0% to 20.0% of FeSO₄; 0.5% to 2.0% of zero-valent iron nanoparticles (nZVI); 5.0% to 10.0% of magnetic iron oxide nanoparticles (Fe₃O₄-NPs); 30.0% to 50.0% of citric acid; 1.0% to 5.0% of a dispersant 5040; 0.2% to 1.0% of xanthan gum; 1.0% to 5.0% of magnesium aluminum silicate; and water as a balance.

### CROSS REFERENCE TO RELATED APPLICATION

This patent application claims the benefit and priority of Chinese Patent Application No. 202410345505.5 filed with the China National Intellectual Property Administration on Mar. 25, 2024, the disclosure of which is incorporated by reference herein in its entirety as part of the present application.

### TECHNICAL FIELD

The present disclosure belongs to the technical field of foliar fertilizer, and in particular relates to an efficient combined nano iron suspension fertilizer and a preparation method and use thereof.

### BACKGROUND

Iron is an essential element for plant growth and development, and is directly involved in chlorophyll synthesis, photosynthetic electron transport, enzyme synthesis and other metabolic processes. Iron deficiency induces yellowing of juvenile leaves, and reduction in photosynthesis and metabolism, thus directly affecting crop yield and posing a threat to food safety. A symptom of physiological iron deficiency is prevalent in most dicotyledonous crops (peanuts, soybeans, citrus, etc.), because the most dicotyledonous crops could not directly absorb poorly-soluble iron oxides (mainly in a form of Fe³⁺) in soil. The poorly-soluble iron oxides could be effectively absorbed and transported by transferrin only after acidification, chelation, and a transformation into Fe²⁺ under an action of an iron chelate reductase. Therefore, such crops have a very low absorption efficiency for the iron, and are very prone to problems of a reduced photosynthetic efficiency and a hindered growth metabolism caused by interveinal chlorosis and the yellowing of juvenile leaves, which thereby directly affects plant growth, crop yield and fruit quality.

In the vast area of alkaline soil and lime soil, the iron deficiency in plants is particularly severe. Applying iron fertilizer to the soil is very prone to formation of the poorly-soluble iron oxides, which deactivates ferrite, prevents the crops from absorbing and transporting iron, and results in physiological disorders. The most effective agricultural measures at present is foliar spraying, which effectively avoids fixation with carbonates, phosphates, hydroxides, etc. in the soil as well as antagonism against other nutrients (P/Zn/Mn, etc.), and could directly act on leaves to rapidly relieve the yellowing. Additionally, an amount for the foliar spraying is only ⅕ to 1/10 of that for root use, which is more economical. However, there are limitations to conventional foliar iron fertilizer. For example, in the air, ferrous sulfate (FeSO₄) is very prone to being oxidized to Fe³⁺ with a poor mobility, and under rainfall conditions, both an ionic iron (e.g. FeSO₄) and a chelated iron (e.g. iron citrate, Fe-Cit) are prone to leaching loss. With a quick but short-acting fertilizer effect, both of them must be sprayed multiple times to realize an effective control, and thus are inevitably limited by environmental factors and labor costs.

### SUMMARY

In order to solve problems that a conventional iron fertilizer is prone to oxidation and leaching loss and has a short-acting effect, the present disclosure provides an efficient combined nano iron suspension fertilizer with advantages of good oxidation resistance and strong anti-leaching property. The efficient combined nano iron suspension fertilizer adopts a combination of a short-acting property and a long-acting property, which could not only relieve yellowing of crops rapidly, but also prolong duration of iron fertilizer effect, thereby effectively reducing a labor cost of spraying fertilizer multiple times.

The present disclosure also provides a preparation method and use of the efficient combined nano iron suspension fertilizer.

The present disclosure is achieved by the following technical solutions.

The present disclosure provides an efficient combined nano iron suspension fertilizer, which is prepared from ingredients including, in mass percentage:

10.0% to 20.0% of FeSO₄; 0.5% to 2.0% of zero-valent iron nanoparticles (nZVI); 5.0% to 10.0% of magnetic iron oxide nanoparticles (Fe₃O₄-NPs); 30.0% to 50.0% of citric acid; 1.0% to 5.0% of a dispersant 5040; 0.2% to 1.0% of xanthan gum; 1.0% to 5.0% of magnesium aluminum silicate; and water as a balance.

In some embodiments, the efficient combined nano iron suspension fertilizer is prepared from the ingredients including, in mass percentage:
16.3% of the FeSO₄; 1.0% of the nZVI; 8.3% of the Fe₃O₄-NPs; 44.7% of the citric acid; 4.0% of the dispersant 5040; 0.6% of the xanthan gum; 2.0% of the magnesium aluminum silicate; and the water as a balance.

In some embodiments, the nZVI and the Fe₃O₄-NPs each have an average particle size of 50 nanometers (nm).

Based on the same inventive concept, the present disclosure provides a method for preparing the efficient combined nano iron suspension fertilizer, including:
preparing an aqueous FeSO₄ solution; and
adding the nZVI, the Fe₃O₄-NPs, the citric acid, the dispersant 5040, the xanthan gum and the magnesium aluminum silicate to the aqueous FeSO₄ solution, fully stirring for dissolution, and ultrasonicating for 3 h to obtain the efficient combined nano iron suspension fertilizer.

Based on the same inventive concept, the present disclosure provides use of the efficient combined nano iron suspension fertilizer in preparation of foliar fertilizer for a plant.

In some embodiments, the plant includes one selected from the group consisting of a peanut and a pear.

Based on the same inventive concept, the present disclosure also provides a method for using the efficient combined nano iron suspension fertilizer, including: diluting the efficient combined nano iron suspension fertilizer by 200 times and then spraying onto a surface of a leaf of a plant.

In some embodiments, the plant includes one selected from the group consisting of the peanut and the pear.

One or more technical solutions in some embodiments of the present disclosure at least have the following technical effects or advantages.

1. The present disclosure provides an efficient combined nano iron suspension fertilizer, in which, nZVI added as an antioxidant brings about a targeting reaction with Fe³⁺ to form Fe²⁺, thereby avoiding or reducing the oxidation of FeSO₄; besides, a combination of a conventional iron fertilizer FeSO₄ and a nano iron fertilizer (i.e., magnetic iron oxide nanoparticles, Fe₃O₄-NPs) enables the suspension fertilizer to have advantages of both a short-acting fertilizer and a long-acting fertilizer, thereby relieving yellowing of crops rapidly, prolonging duration of iron fertilizer effect, making it unnecessary to spray the fertilizer multiple times, and reducing labor costs. Further, an addition of citric acid as a multifunctional auxiliary activator facilitates the biodegradation, absorption and transport of nano iron. A final addition of surfactants (a dispersant 5040+xanthan gum+magnesium aluminum silicate) is conducive to suspension properties of the nano iron. Finally, the efficient combined nano iron suspension fertilizer suitable for use in foliar spraying is obtained.

2. The present disclosure provides the efficient combined nano iron suspension fertilizer, which has a combination of a short-acting property and a long-acting property to relieve the symptom of the yellowing, prolong the duration of the iron fertilizer effect, and effectively reduce the labor cost of spraying fertilizer multiple times, and which has beneficial effects such as a good oxidation resistance, a strong anti-leaching property, a good suspension property and a good fertilizer effect. Therefore, with its foliar spraying condition not limited by rainfall environment, the fertilizer is proven to be effective in use for foliar spraying of various crops and field verification of fertilizer effect.

### BRIEF DESCRIPTION OF THE DRAWINGS

In order to illustrate the technical solutions in the embodiments of the present disclosure more clearly, the drawings that need to be used in the description of the embodiments will be briefly described. Apparently, the drawings in the description below are some embodiments of the present disclosure, and those of ordinary skill in the art may still derive other drawings from these drawings without creative efforts.

FIG. 1 shows the content of Fe²⁺ in the FeSO₄ solution exposed to air after addition of different mass percentages of the nZVI in Example 1.

FIG. 2A shows transmission electron microscope (TEM) images of the nZVI (50 nm) in Example 2.

FIG. 2B shows transmission electron microscope (TEM) images of the magnetic iron oxide nanoparticles, Fe₃O₄-NPs (50 nm) in Example 2.

FIG. 2C shows transmission electron microscope (TEM) images of the alpha-phase iron (III) oxide nanoparticles, α-Fe₂O₃-NPs (50 nm) in Example 2.

FIG. 2D shows transmission electron microscope (TEM) images of the gamma-phase iron (III) oxide nanoparticles, γ-Fe₂O₃-NPs (50 nm)) in Example 2.

FIG. 3 shows a schematic diagram of a test quantifying the leaching amount and the adhesion amount of the nano iron particles on the peanut leaves in Example 2.

FIG. 4A shows diagrams of effective spraying amount of the different nano iron materials in peanut leaves in Example 2.

FIG. 4B shows effective adhesion amount of the different nano iron materials in peanut leaves in Example 2

FIG. 4C shows leaching amount of the different nano iron materials in peanut leaves in Example 2.

FIG. 5A shows physical object images of the growth of the iron-deficient peanuts with the foliar spraying of different nano iron fertilizers under rainfall conditions in Example 2.

FIG. 5B is a graph of plant height of the growth of the iron-deficient peanuts with the foliar spraying of different nano iron fertilizers under rainfall conditions in Example 2.

FIG. 5C is a graph of biomass of above-ground portion of the growth of the iron-deficient peanuts with the foliar spraying of different nano iron fertilizers under rainfall conditions in Example 2.

FIG. 6A is a physical leaf yellowing image of the iron-deficient peanuts with their leaves sprayed with different nano iron fertilizers under rainfall conditions in Example 2.

FIG. 6B is a graph of an SPAD diagram of the iron-deficient peanuts with their leaves sprayed with different nano iron fertilizers under rainfall conditions in Example 2

FIG. 6C is a graph of an iron concentration of the iron-deficient peanuts with their leaves sprayed with different nano iron fertilizers under rainfall conditions in Example 2.

FIG. 7A shows physical object images of the growth of iron-deficient peanuts sprayed with combined iron fertilizers of different concentrations of Fe₃O₄-NPs dose and FeSO₄ in Example 3.

FIG. 7B is a graph of plant height of the growth of iron-deficient peanuts sprayed with combined iron fertilizers of different concentrations of Fe₃O₄-NPs dose and FeSO₄ in Example 3.

FIG. 7C is a graph of biomass of the above-ground portion of the growth of iron-deficient peanuts sprayed with combined iron fertilizers of different concentrations of Fe₃O₄-NPs dose and FeSO₄ in Example 3.

FIG. 8A is images of physical leaf yellowing of the iron-deficient peanuts sprayed with combined iron fertilizers of different concentrations of Fe₃O₄-NPs dose and FeSO₄ in Example 3.

FIG. 8B is a SPAD graph of the iron-deficient peanuts sprayed with combined iron fertilizers of different concentrations of Fe₃O₄-NPs dose and FeSO₄ in Example 3.

FIG. 8C is a graph of a net photosynthesis rate diagram of the iron-deficient peanuts sprayed with combined iron fertilizers of different concentrations of Fe₃O₄-NPs dose and FeSO₄ in Example 3.

FIG. 9A is images of a physical leaf yellowing of an iron-deficient peanut sprayed with a citric acid-containing iron fertilizer and an iron-deficient peanut sprayed with a citric acid-free iron fertilizer in Example 4.

FIG. 9B is a SPAD graph of an iron-deficient peanut sprayed with a citric acid-containing iron fertilizer and an iron-deficient peanut sprayed with a citric acid-free iron fertilizer in Example 4.

FIG. 9C is a graph of a leaf iron concentration of an iron-deficient peanut sprayed with a citric acid-containing iron fertilizer and an iron-deficient peanut sprayed with a citric acid-free iron fertilizer in Example 4.

FIG. 9D is image of a nano iron activation effect contrast agents one without and one with citric acid.

FIG. 9E is a graph showing dissolution of Fe₃O₄ NPs with and without citric acid vs time.

FIG. 10 shows a comparison diagram of effects of surfactant presence and surfactant absence on the suspension property of nano iron in Example 5.

FIG. 11A is an image of iron-deficient pear trees used in Example 6.

FIG. 11B is an image of the iron-deficient pear trees after the foliar spraying with ferrous sulfate in Example 6.

FIG. 11C is an image of the iron-deficient pear trees after the foliar spraying with iron citrate in Example 6.

FIG. 11D is an image of the iron-deficient pear trees after the foliar spraying with the nano iron suspension fertilizer in Example 6.

FIG. 11E shows images of pear tree leaves sprayed with different materials in Example 6.

FIG. 11F shows images of resulting fruits sprayed with different materials in Example 6.

FIG. 11G is a SPAD graph of showing the effect of different fertilizers in the foliar spraying of iron-deficient pear trees in Example 6.

FIG. 11H is a graph of Fe concentrations in a leaf from different fertilizers after the foliar spraying of iron-deficient pear trees in Example 6.

FIG. 11I is a graph showing Fe concentrations in a fruit from different fertilizers after the foliar spraying of iron-deficient pear trees in Example 6.

### DETAILED DESCRIPTION OF THE EMBODIMENTS

The present disclosure will be explained in detail below in conjunction with specific embodiments and examples, and thereby advantages and various effects of the present disclosure will be presented more clearly. It should be appreciated by those skilled in the art that these specific embodiments and examples are provided as illustration rather than limitation on the present disclosure.

Throughout the description, unless otherwise particularly stated, the terms used herein should be construed as having the meaning commonly used in the art. Therefore, unless otherwise defined, all technical and scientific terms used herein have the same meaning as commonly understood by those skilled in the art to which the present disclosure belongs. In case of contradiction, the description should prevail.

Unless otherwise particularly stated, various raw materials, reagents, instruments and devices, etc. used in the present disclosure are all available on the market or may be prepared by existing methods.

The overall concept of the present disclosure is as follows.

There are limitations to conventional iron fertilizers. For example, in the air, ferrous sulfate is very prone to being oxidized to Fe³⁺ with a poor mobility, and under rainfall conditions, both an ionic iron and a chelated iron (e.g. iron citrate) are prone to leaching loss. With a quick but short-acting fertilizer effect, both of them must be sprayed multiple times to achieve effective control, and thus are inevitably limited by environmental factors and labor costs

Compared with the conventional iron fertilizers, nano iron fertilizers have characteristics such as a small size, a large specific surface area, an anti-leaching property, a large proportion of ferrite, a small use amount and a long-acting effect, which just make up for shortcomings of the conventional iron fertilizers. The nano iron fertilizers have a small size effect to effectively penetrate through a wax layer of a leaf; the large specific surface area to realize a large effective contact surface with the leaf and avoid proneness to leaching loss; a high iron atom proportion (greater than or equal to 70%, much higher than that of the conventional iron fertilizers (FeSO₄ 20%) to realize the small use amount under the same iron equivalent; and the long-acting effect is caused by characteristics such as slow biodegradation, migration and transformation. It is noteworthy that a nano iron also has some defects limiting its use in agricultural production. For example, nano toxicity is prevalent in a nano material with a high concentration, a slow-acting effect could not relieve an element deficiency symptom rapidly, and most poorly-soluble nanoparticles prone to agglomeration could not be made into a liquid suspending agent easily.

Based on this, in the present disclosure, the nano iron fertilizers are optimized by overcoming the disadvantages of the conventional iron fertilizers and combining with the advantages of the nano iron fertilizers; a combination of the conventional iron fertilizer and the nano iron fertilizer is employed to realize a combination of a short-acting fertilizer and a long-acting fertilizer; and an addition of multifunctional auxiliary activator and surfactant makes up for use limitations of the nano iron fertilizer. Finally, an efficient combined nano iron suspension fertilizer is obtained, used for foliar spraying of various crops, and subjected to iron fertilizer effect verification.

The present disclosure provides a method for preparing the efficient combined nano iron suspension fertilizer, including the steps of:
(i) subjecting different nano iron materials to tests in which an adhesion amount and a leaching amount of nano iron particles on peanut leaves are quantified and compared, to screen Fe₃O₄-NPs (50 nm) with strongest anti-leaching properties;
(ii) performing the foliar spraying of different nano iron fertilizers under rainfall conditions, and comparing their fertilizer effects on iron-deficient peanuts, to obtain the Fe₃O₄-NPs as the most effective nano iron material for relieving iron deficiency;
(iii) performing the foliar spray of combined fertilizers of FeSO₄ and different concentrations of the Fe₃O₄-NPs for verification of the fertilizer effect on the iron-deficient peanuts, to obtain the Fe₃O₄-NPs without nano toxicity and an optimal application concentration of 300 milligrams/liter (mg/L) Fe equivalent; and
(vi) performing a final verification to obtain an optimal application concentration of FeSO₄ (300 mg/L Fe equivalent)+Fe₃O₄-NPs (300 mg/L Fe equivalent) for a short-acting and long-acting combined iron fertilizer.

According to the method of the present disclosure, for the optimal application concentration (300 mg/L Fe equivalent) of the Fe₃O₄-NPs in step (iii), the present disclosure further optimizes and improves activity and utilization efficiency of the nano iron by the following way: respectively adding citric acid in Fe/citric acid molar mass ratios of 1:½, 1:1, and 1:2, i.e., respectively adding 516 mg/L, 1032 mg/L, and 2064 mg/L citric acid, and according to fertilizer effect verification, the optimal molar mass ratio of Fe to citric acid is 1/1.

According to the method of the present disclosure, the Fe₃O₄-NPs in step (iii) with a concentration of 300 mg/L Fe equivalent are first concentrated by 200 times, and then a suspension property of a concentrated nano iron (60 g/L Fe equivalent) is further optimized by the following way to facilitate the preparation into a foliar fertilizer capable of practical use: adding surfactants in different mass percentages, with mass percentage gradients set as 1.0%, 2.0%, 3.0%, 4.0% and 5% for magnesium aluminum silicate, 0.2%, 0.4%, 0.6%, 0.8% and 1.0% for xanthan gum, and 1.0%, 2.0%, 3.0%, 4.0% and 5.0% for a dispersant 5040 respectively, and then performing screening and comparison. Finally, 2.0% of the magnesium aluminum silicate, 0.6% of the xanthan gum, and 4.0% of the dispersant 5040 are preferred.

As shown in Table 1, the efficient combined nano iron suspension fertilizer of the present disclosure has an iron content of 13.0% (conforming to the requirement of GB/T 17420-2020, Trace Element Foliar Fertilizer, i.e., greater than or equal to 10%), and there are no particular limitations on fertilizer application environment, and the application under rainfall conditions is possible.

The efficient combined nano iron suspension fertilizer of the present disclosure is universally-applicable, and has a significant effect in both the foliar spraying of various crops and the field verification of fertilizer effect.

The efficient combined nano iron suspension fertilizer and the preparation method and use thereof will be described in detail below in conjunction with examples and experimental data.

Unless otherwise stated, reagents and instruments used in the following examples are all commercially available.

A instrument for characterizing the nano iron materials in the following examples is a transmission electron microscope, and the device used is Tecnai G2 F20 U-TWIN transmission electron microscope (TEM) from FEI Corporation, USA.

A device used for plant sample digestion is Auto digblock S60UP automatic tissue digestion instrument from LabTech Corporation, USA. A mixture of HNO₃—H₂O₂ (5 mL and 2 mL, GR) is used for 0.2 g of plant tissue to perform a complete digestion at 150° for 2 h.

As for a content of Fe element, an inductively coupled plasma optical emission spectrometer (ICP-OES, 5110 SVDV, Agilent, Santa Clara, CA, USA) is used to determine a concentration of mineral nutrients in digestive juice, and nutrients in citrus leaves (GBW10020, PR China) are analyzed to verify the accuracy and precision of nutrient digestion analysis methods.

A device used for absorbance value is V-5100 visible spectrophotometer from Shanghai Metash Instruments Co., Ltd., China.

As for SPAD, an SPAD502 chlorophyll meter (SPAD-502 plus, from Konica Minolta Inc, Japan) is used for determination.

A net photosynthesis rate is measured using LI-6800 new generation photosynthesis system (LI-6800, from LI-COR Corporation, USA).

A device used for ultrasonic dispersion is KO-500DE ultrasonic instrument from Kunming

### Ultrasonic Instrument Co., Ltd., China.

A device used for shaking dispersion is TS-180C horizontal thermostatic shaker from Shanghai Tiancheng Experimental Instrument Manufacturing Co., Ltd., China.

### Example 1

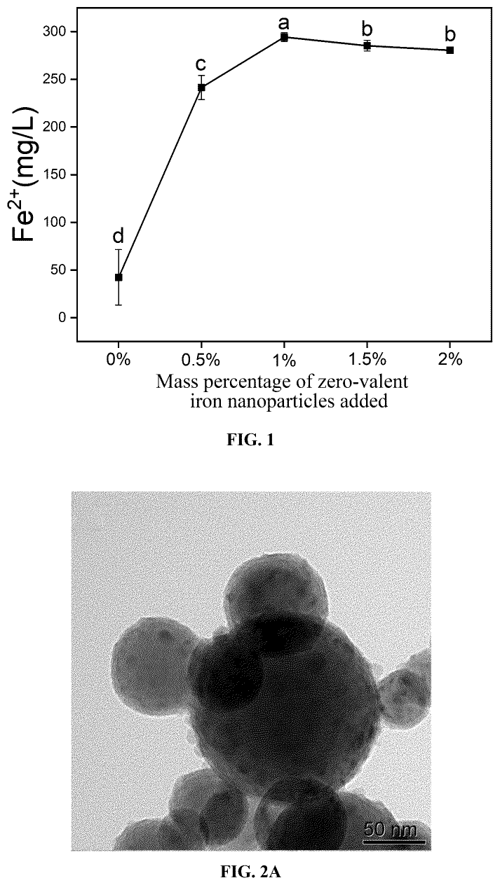

In this example, screening of an antioxidant was performed, which specifically was performed by the following procedures.
(i) 0%, 0.5%, 1.0%, 1.5% and 2.0% of nZVI were respectively added to 100 mL of an FeSO₄ (60 g/L Fe equivalent) solution, and mixed well, and then a bottle cap was opened and a resulting mixture was subjected to exposure to air for 1 day.
(ii) After 1 day of oxidation and exposure to air, 10 mL of a solution supernatant was aspirated for determination of a Fe²⁺ concentration.
(iii) The Fe²⁺ concentration was measured using spectrophotometry. Standard FeSO₄ solutions with 0 mg/L Fe²⁺, 1 mg/L Fe²⁺, 2 mg/L Fe²⁺, 4 mg/L Fe²⁺, 6 mg/L Fe²⁺, 8 mg/L Fe²⁺, 10 mg/L Fe²⁺, respectively each were added with o-phenanthroline as a developer. At a pH of 3.8, a V-5100 visible spectrophotometer was used to measure absorbance values A₁-A₅ at a wavelength of 510 nm. Finally, a standard graph was obtained from Fe²⁺ labeled concentration values and the absorbance values.
(iv) A test solution sampled in step (ii) of Example 1 was diluted by 200 times, and o-phenanthroline was added as a developer. An absorbance value A was measured at the same pH and wavelength, and calculation was performed to obtain the Fe²⁺ concentration in the test solution.
(v) Experimental results are shown in FIG. 1, the solution added with 1.0% of the nZVI has the highest Fe²⁺ concentration and the best antioxidant effect.

### Example 2

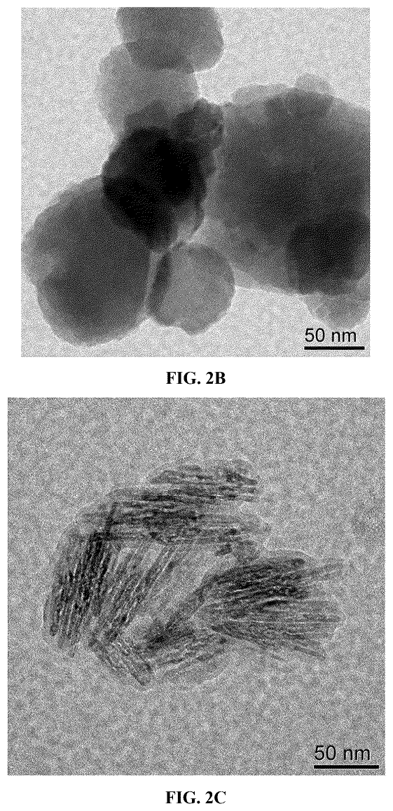

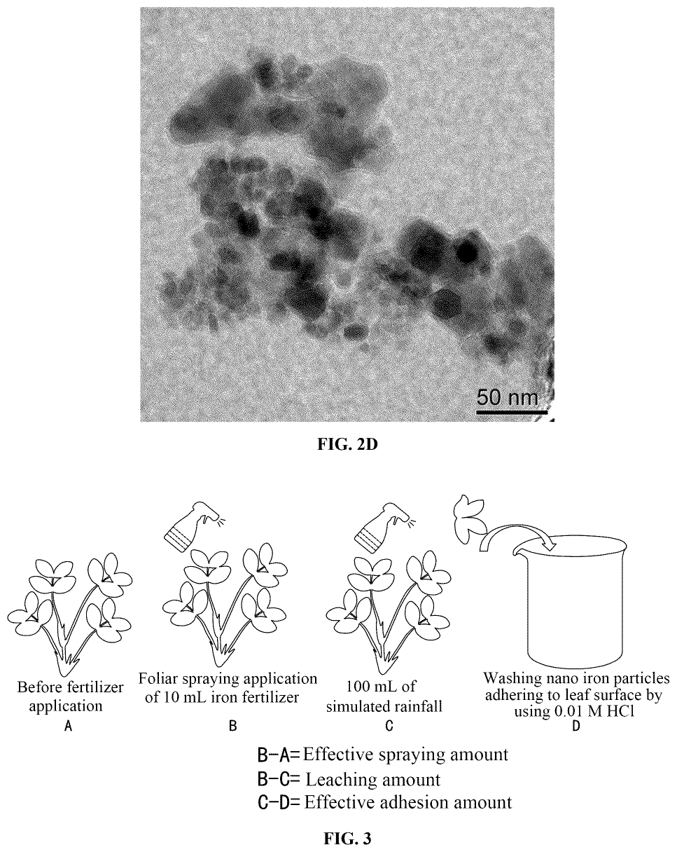

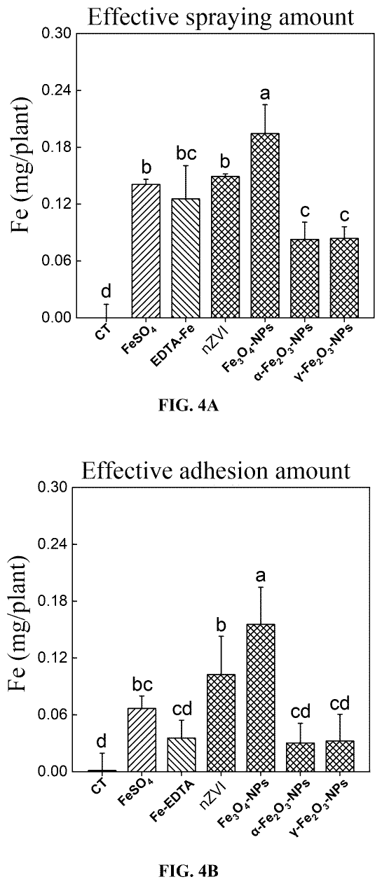

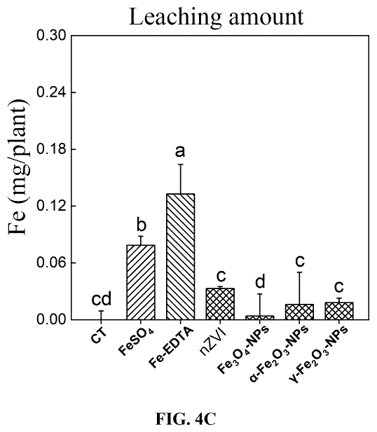

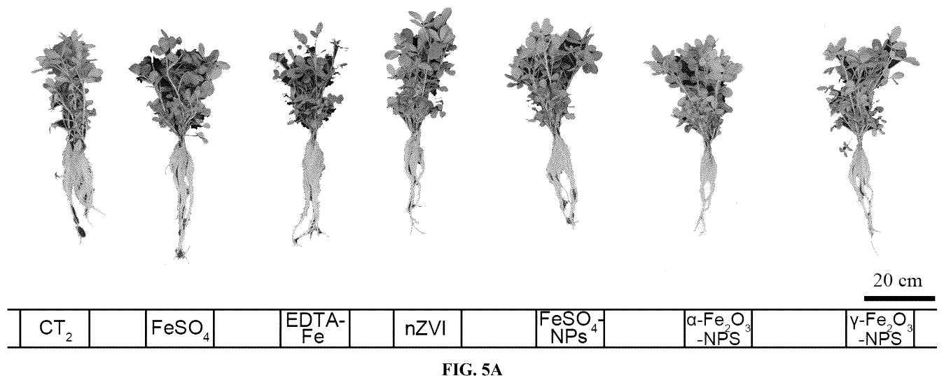

In this example, screening of a nano iron fertilizer was performed, which specifically was performed by the following procedures.
(i) 300 mg/L Fe equivalent of different nano iron fertilizers (nZVI (50 nm); Fe₃O₄-NPs (50 nm); α-Fe₂O₃-NPs (50 nm); and γ-Fe₂O₃-NPs (50 nm), as shown in FIGS. 2A-2D) were compared with conventional iron fertilizers (FeSO₄ and Fe-EDTA), a test of a leaching amount and an adhesion amount of nano iron particles on peanut leaves was used as a way to quantify and compare the adhesion amount and the leaching amount of different iron fertilizers on the peanut leaves. Specifically, the test was divided into four steps: step one was state A in which the iron fertilizer had not been applied (i.e., a leaf background iron value); step two was state B in which a foliar spraying amount of the iron fertilizer was 10 mL/plant (i.e., the leaf background iron value+an amount of the iron fertilizer applied to the leaf); step three was state C in which a simulated rainfall amount was 100 mL/plant (i.e., an iron content after the state B was subjected to leaching); and step four was to wash the leaf adhered with the nano iron by using 0.1 M HCl was used to (i.e., a iron content after the state C was subjected to washing). The leaves in all states were subjected to HNO₃/H₂O₂ digestion, and then an ICP-OES was used to detect a Fe concentration and a Fe content. The adhesion amount was obtained by deducting the iron content of the state D from the iron content of the state C, and the leaching amount was obtained by deducting the iron content of the state C from the iron content of the state B (as shown in FIGS. 3 and 4). It was verified by experimental results that Fe₃O₄-NPs (50 nm) had the smallest leaching amount, the largest adhesion amount, and the strongest anti-leaching capability.

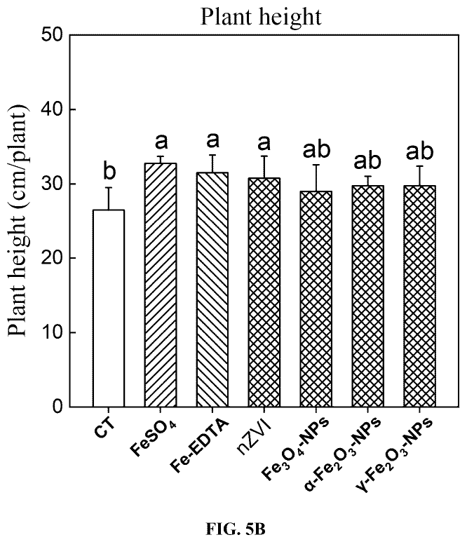

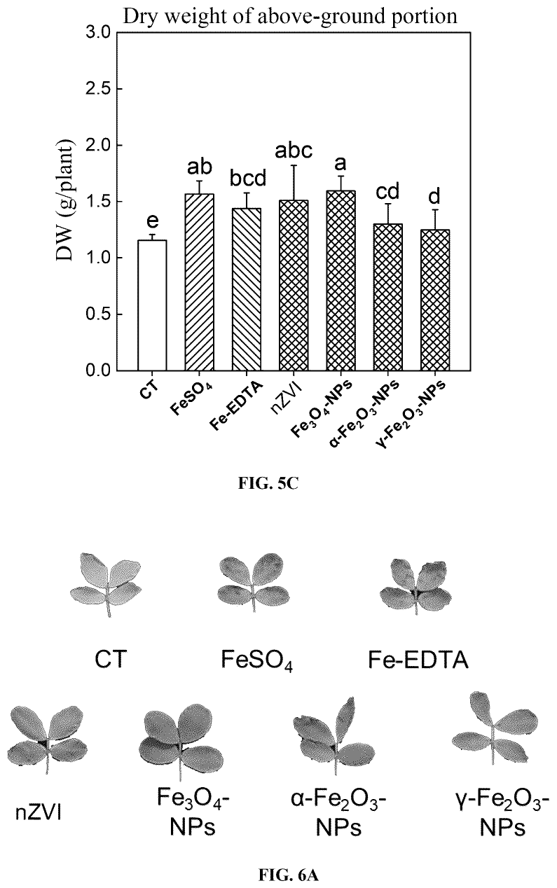

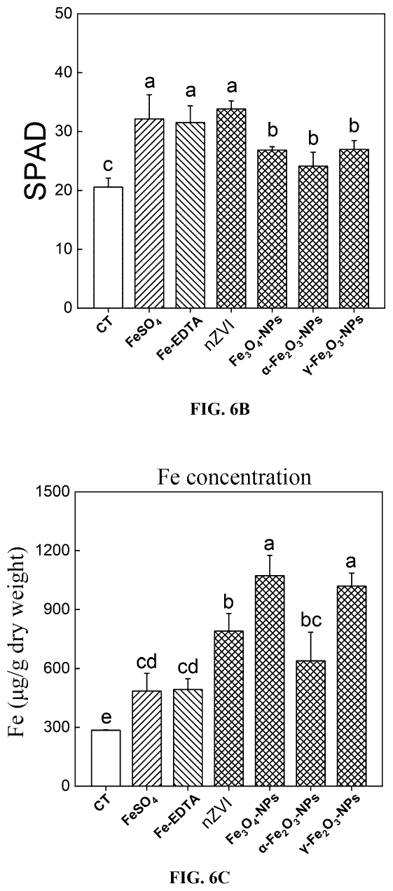

(ii) A material was subjected to the same treatment as that set in step (i) of Example 2. Different nano iron fertilizers were sprayed on iron-deficient peanut leaves, and 10 days after iron deficiency treatment, the foliar spraying of the iron fertilizer was performed 3 times in an amount of 10 mL/plant for each time, with an interval of 10 days. 10 days after the last foliar spraying, peanut samples were harvested for measurement of plant height, biomass, leaf SPAD and iron concentration (as shown in FIGS. 5 and 6). Results show that Fe₃O₄-NPs (50 nm) had the largest above-ground biomass, the highest leaf Fe concentration, and the best fertilizer effect under rainfall conditions. In FIGS. 4 to 6, a CT group was water; a Fe-EDTA group was ethylenediaminetetraacetic acid iron salt, i.e., EDTA-Fe (C₃₀H₃₆Fe₄N₆O₂₄), and likewise was 300 mg/L Fe equivalent.

### Example 3

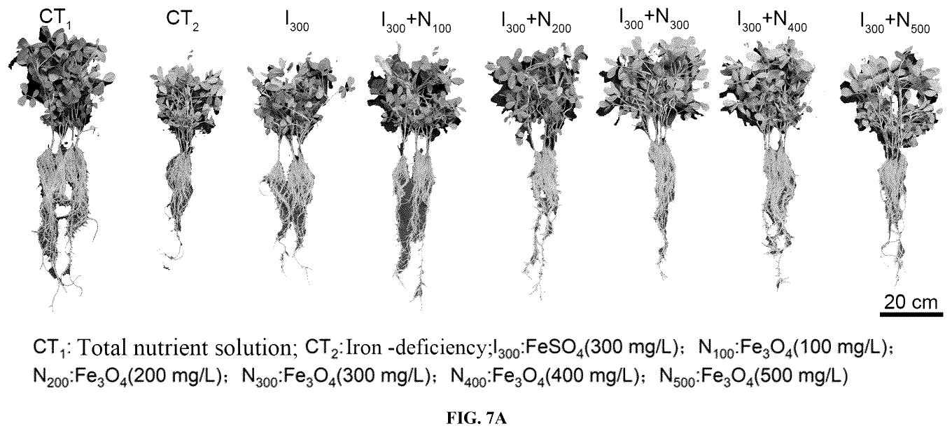

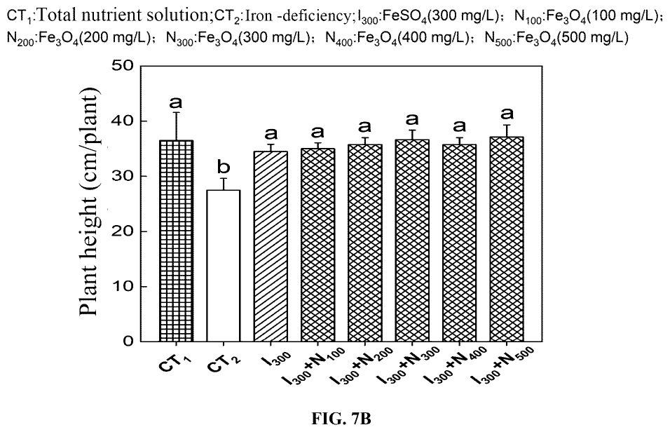

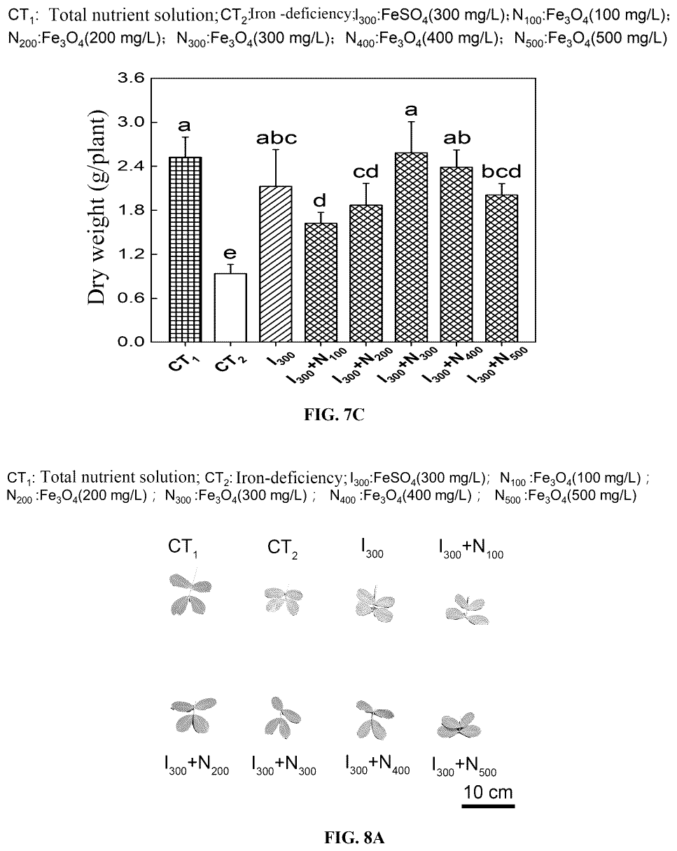

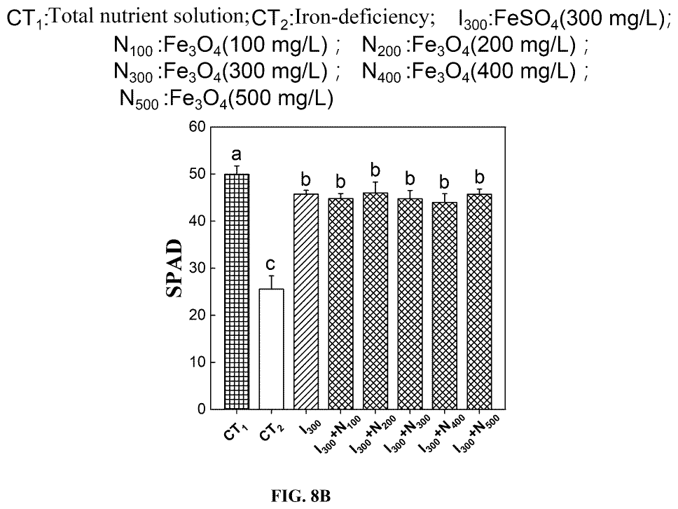

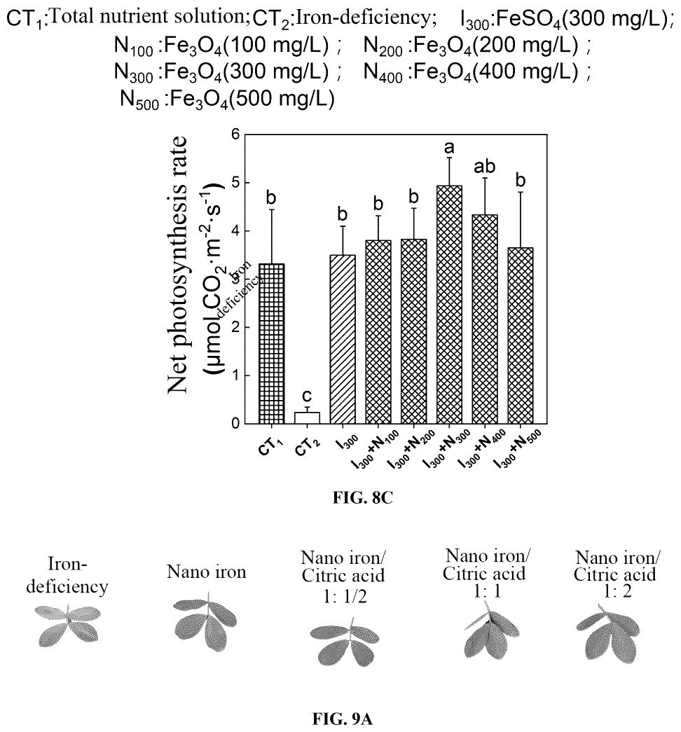

In this example, screening of a nano iron fertilizer concentration was performed, which specifically was performed by the following procedures.
(i) Foliar spraying of combined iron fertilizers of 300 mg/L Fe equivalent of FeSO₄ and different concentration doses (100 mg/L Fe equivalent; 200 mg/L Fe equivalent; 300 mg/L Fe equivalent; 400 mg/L Fe equivalent; and 500 mg/L Fe equivalent) of Fe₃O₄-NP nano iron fertilizer was performed 3 times on peanut leaves obtained after an iron deficiency treatment for 10 days in an amount of 10 mL/plant for each times, with an interval of 10 days. 10 days after the last foliar spraying, peanut samples were harvested for measurement of plant height and biomass (as shown in FIGS. 7A-7C), and results show that the optimal application concentration of Fe₃O₄-NPs was 300 mg/L Fe equivalent, at which the above-ground biomass was the largest.
(ii) During harvest, the peanut leaves were randomly selected, a chlorophyll content meter was used to determine leaf SPAD, and a photosynthesis system was used to determine a net photosynthesis rate of leaf (as shown in FIGS. 8A-8C). Results show that FeSO₄ (300 mg/L Fe equivalent)+Fe₃O₄-NPs (300 mg/L Fe equivalent) have the optimal leaf SPAD and net photosynthesis rate.

### Example 4

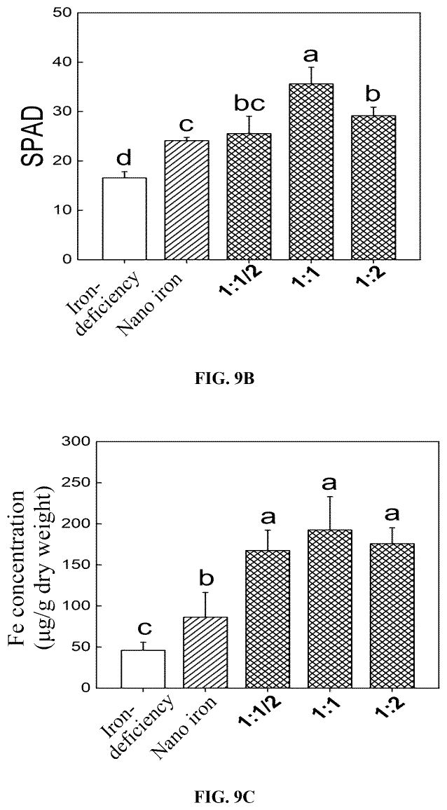

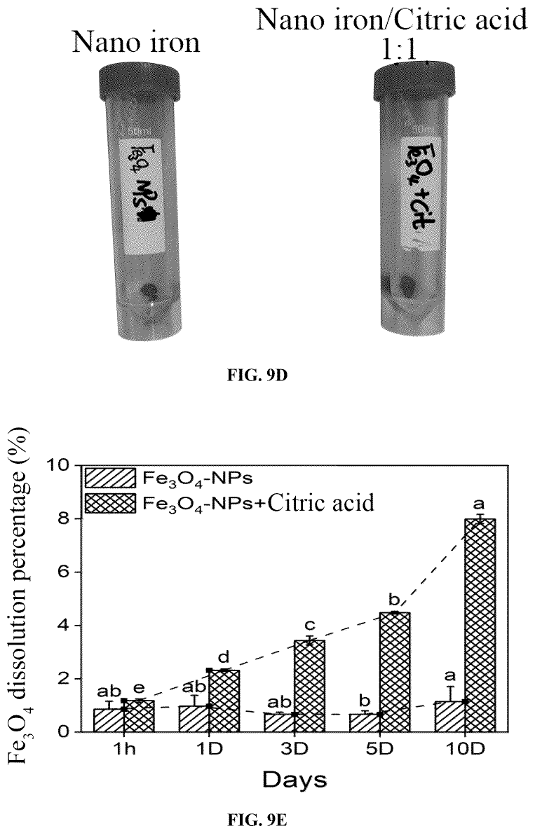

In this example, screening of a citric acid concentration was performed, which specifically was performed by the following procedures.
(i) Foliar spraying of iron fertilizers mixed with 300 mg/L Fe equivalent of Fe₃O₄-NPs and different concentration doses of citric acid (516 mg/L, 1032 mg/L and 2064 mg/L, converted from Fe/citric acid molar mass ratios of 0.5/1, 1/1 and 1/2 respectively) was performed 3 times on peanut leaves obtained after an iron deficiency treatment for 10 days in an amount of 10 mL/plant for each time, with an interval of 10 days. 10 days after the last foliar spraying, during harvest, the peanut leaves were randomly selected, a chlorophyll content meter was used to determine leaf SPAD, and an ICP-OES was used to determine leaf iron concentration (as shown in FIG. 9A/FIG. 9B/FIG. 9C of FIGS. 9A-9E). Results show that a group treated with the iron fertilizer in which the molar mass ratio of the Fe to the citric acid was 1/1 had the highest leaf SPAD and leaf iron concentration.
(ii) In order to verify activation effect of the citric acid on nano iron, a group treated with a citric acid-free fertilizer was compared with a group treated with a fertilizer in which the molar mass ratio of the Fe to the citric acid was 1/1. A supernatant was taken respectively after 1 hour, 1 day, 3 days, 5 days and 10 days for determination of a Fe concentration which was converted into a proportion of dissolved Fe₃O₄-NPs to plot a trend graph showing the proportion of the dissolved Fe₃O₄-NPs over time (as shown in FIG. 9D/FIG. 9E). Results show that after 10 days, the proportion of the dissolved Fe₃O₄-NPs of the fertilizer added with the citric acid is as high as 8.2%, which is nearly 5 times that (1.7%) of the group treated with the citric acid-free fertilizer.

### Example 5

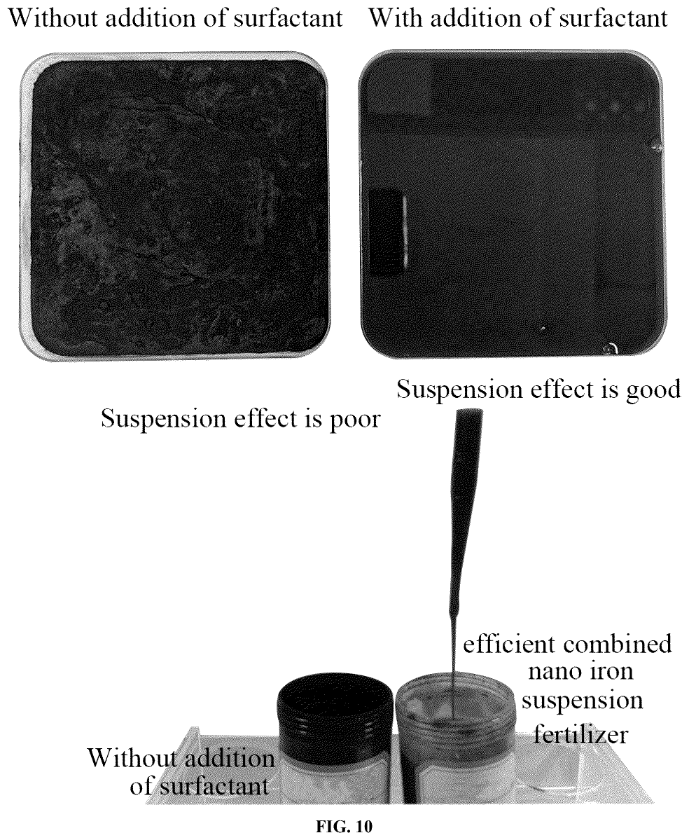

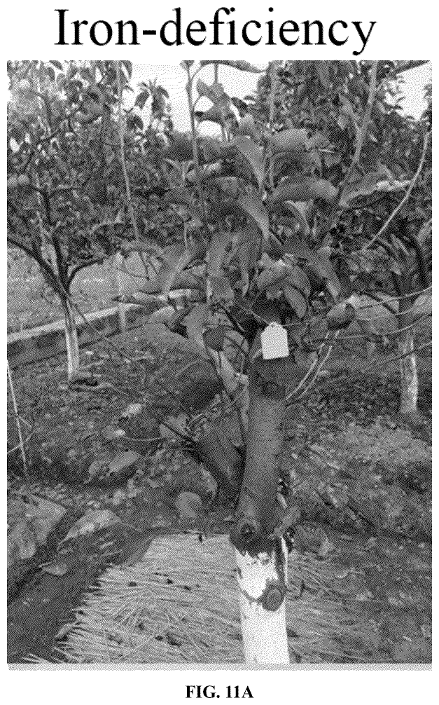

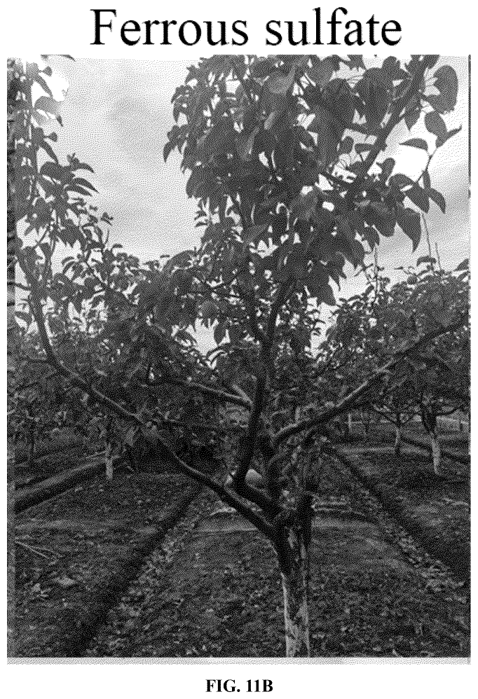

In this example, screening of a surfactant concentration was performed, which specifically was performed by the following procedures.
(i) 60 g/L Fe equivalent of concentrated Fe₃O₄-NPs were mixed with different surfactants, with mass percentage gradients set as 1.0%, 2.0%, 3.0%, 4.0% and 5% for magnesium aluminum silicate, 0.2%, 0.4%, 0.6%, 0.8% and 1.0% for xanthan gum, and 1.0%, 2.0%, 3.0%, 4.0% and 5.0% for a dispersant 5040 respectively, and then screening and comparison were performed. Finally, 2.0% of the magnesium aluminum silicate, 0.6% of the xanthan gum, and 4.0% of the dispersant 5040 are preferred (as shown in FIG. 10).
(ii) A finally-obtained efficient combined nano iron suspension fertilizer consisted of, in mass percentage, 16.3% of FeSO₄, 1.0% of nZVI, 8.3% of the Fe₃O₄-NPs, 44.7% of citric acid, 2.0% of the magnesium aluminum silicate, 0.6% of the xanthan gum and 4.0% of a dispersant 5040 (see Table 1). Its effective iron content was 13.0% of Fe (conforming to the requirement of GB/T 17420-2020, Trace Element Foliar Fertilizer, i.e., greater than or equal to 10%).
(iii) Operations for preparing 1 L of an 200-fold concentrated efficient combined nano iron suspension fertilizer were as follows: First, 299 g of ferrous sulfate heptahydrate (FeSO₄·7H₂O) or 163 g of ferrous sulfate (FeSO₄), 10 g of nZVI (50 nm), 83.0 g of Fe₃O₄-NPs (50 nm), 430 g of the citric acid, 20 g of the magnesium aluminum silicate (Al₂MgO₈Si₂), 6 g of the xanthan gum and 4 mL of the dispersant 5040 were weighed respectively, mixed into a 1000 mL volumetric flask, and diluted to 1 L to obtain a mixture.

In this example, the 200-fold concentrated efficient combined nano iron suspension fertilizer mainly includes the ferrous sulfate (60 g/L, 6%) and the Fe₃O₄-NPs (60 g/L, 6%), which, after diluted by 200 times, respectively correspond to a FeSO₄ concentration (300 mg/L Fe equivalent) and a Fe₃O₄-NPs concentration (300 mg/L Fe equivalent) at a time of foliar spraying. 1.0% of nZVI were mainly used to inhibit oxidation of Fe²⁺ and thereby effectively improve oxidation resistance of an efficient combined nano iron suspension fertilizer. 2.0% of the magnesium aluminum silicate, 0.6% of the xanthan gum and 4.0% of the dispersant 5040 were surfactant and auxiliary dispersant conducive to suspension effect of nano iron particles.

(iv) Then, the mixture was subjected to ultrasonication for dispersion 3 times by an ultrasonic instrument, each time lasting 1 h. During the ultrasonication, a shaker was intermittently used to mix materials well for 30 minutes, and the finally-obtained efficient combined nano iron suspension fertilizer was used for subsequent fertilizer effect verification.

TABLE 1
Formulation of efficient combined nano iron suspension
fertilizer and mass percentages of ingredients

| | | | | Mass | Mass/volume | |
|---|---|---|---|---|---|---|
| | | | | percentage | (g/mL) of | |
| | | | | of each | substances required | |
| | Molecular | Fe concentration | | ingredient | to prepare 1 L of | |
| Ingredients | weight | (g/L)/(%) | | (%) | efficient nano iron | |
| FeSO₄ | 151.9 | 60 g/L | (6%) | 16.3% | 163 | g |
| Zero-valent iron | 55.85 | 10 g/L | (1%) | 1.0% | 10 | g |
| nanoparticles | | | | | | |
| (nZVI, 50 nm) | | | | | | |
| Magnetic iron | 231.53 | 60 g/L | (6%) | 8.3% | 830 | g |
| oxide | | | | | | |
| nanoparticles | | | | | | |
| (Fe₃O₄—NPs, 50 | | | | | | |
| nm) | | | | | | |
| Magnesium | 262.40 | 0 g/L | (0%) | 2.0% | 20 | g |
| aluminum silicate | | | | | | |
| (Al₂MgO₈Si₂) | | | | | | |
| Xanthan gum | Relative | 0 g/L | (0%) | 0.6% | 6 | g |
| (polysaccharide | molecular mass | | | | | |
| macromolecular | is 1 million or | | | | | |
| compound) | more | | | | | |
| Dispersant 5040 | Molecular | 0 g/L | (0%) | 4.0% | 4 | mL |
| (Sodium salt of | weight range | | | | | |
| modified acrylic | 4500 ± 50 | | | | | |
| homopolymer) | | | | | | |
| Citric acid | 192.13 | 0 g/L | (0%) | 44.7% | 447 | g |
| (C₆H₈O₇) | | | | | | |

| | |
|---|---|
| Total | 130 g/L (13% |
| | of Fe) |

### Example 6

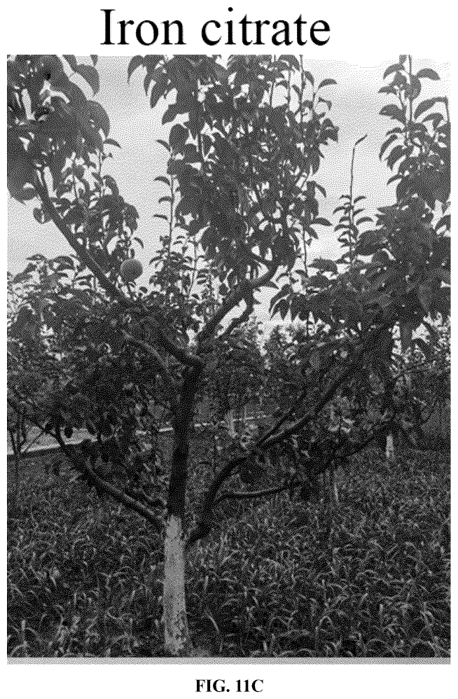

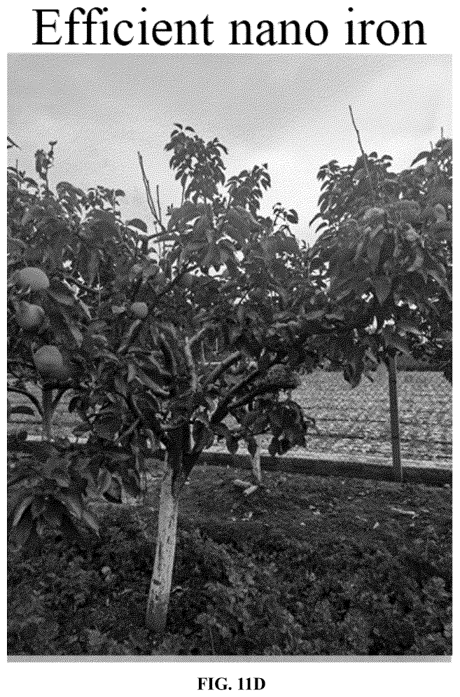

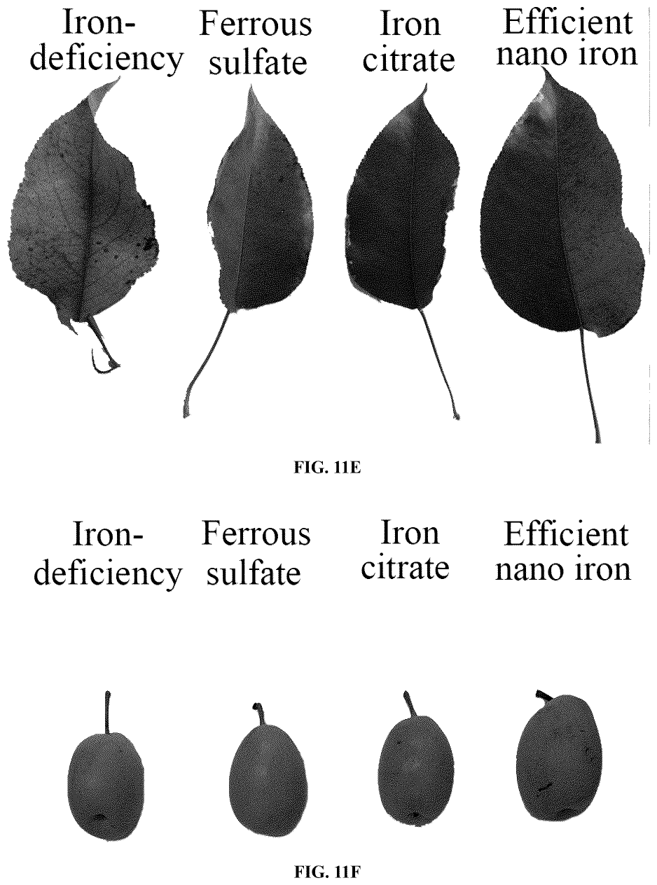

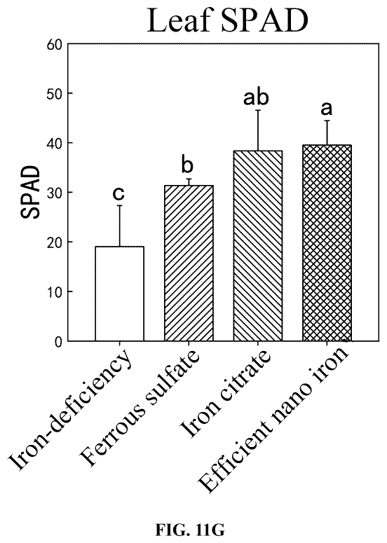

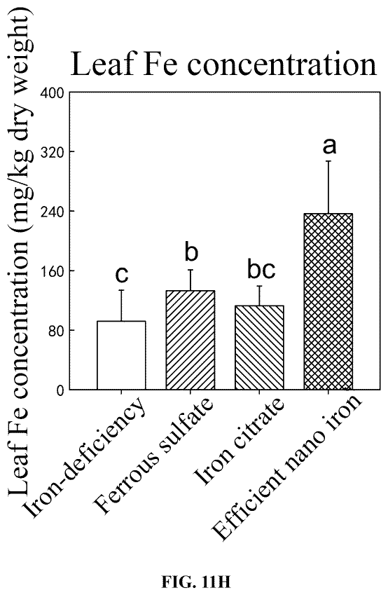

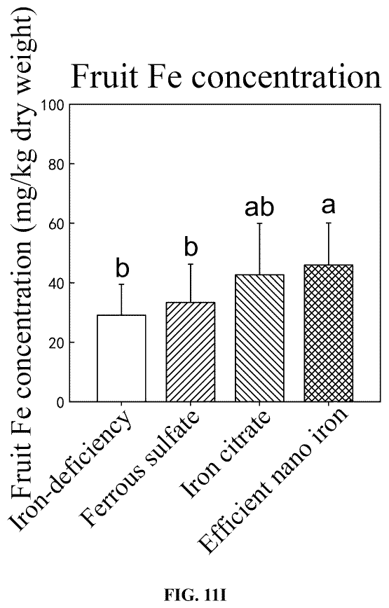

In this example, a fertilizer effect verification of an efficient combined nano iron suspension fertilizer was performed by the following procedures.
(i) The 200-fold concentrated efficient combined nano iron suspension fertilizer in Table 1 was used after being diluted by 200 times, that is, 30 L of water was added with 150 mL of the 200-fold concentrated efficient combined nano iron suspension fertilizer. Compared with FeSO₄ (816 mg/L) and iron citrate (a molecular mass was 244.94, and a mass concentration was 1316 mg/L) (300 mg/L Fe equivalent), during florescence of iron-deficient pear trees, foliar spraying was performed 3 times in a recommended application amount of 30 L/mu for each time, with an interval of 10 days. 60 days after fertilizer application, pear leaves and fruits were picked for determination of a Fe concentration, and results are as shown in FIGS. 11A-11I.
(ii) Likewise, the efficient combined nano iron suspension fertilizer was compared with the FeSO₄, and during florescence of iron-deficient peanuts, foliar spraying was performed 3 times in the same recommended application amount, with an interval of 10 days. 50 days after fertilizer application, peanut leaves and fruits were picked for determination of a Fe concentration, and the results are as shown in Table 2.

Table 2 shows the effect of foliar spraying of efficient combined nano iron suspension fertilizer on mineral nutrients of peanut leaves, peanut shells and peanut kernels in the field in Example 6

| | | Manga- | | |
|---|---|---|---|---|
| | Iron | nese | Copper | Zinc |
| Experiment treatment | (mg/kg) | (mg/kg) | (mg/kg) | (mg/kg) |
| Peanut leaves (control group) | 415 | 13.2 | 2.5 | 9.8 |
| Peanut leaves (ferrous sulfate) | 601 | 17.2 | 3.2 | 9.5 |
| Peanut leaves (efficient | 632 | 23.3 | 2.6 | 11.7 |
| combined nano iron | | | | |
| suspension fertilizer) | | | | |
| Peanut shells (control group) | 239 | 20.5 | 6.8 | 5.3 |
| Peanut shells (ferrous sulfate) | 319 | 22.4 | 7.7 | 7.6 |
| Peanut shells (efficient | 433 | 28.7 | 6.2 | 9.4 |
| combined nano iron | | | | |
| suspension fertilizer) | | | | |
| Peanut kernels (control group) | 26 | 9.8 | 9.1 | 33 |
| Peanut kernels (ferrous sulfate) | 29 | 10 | 10.2 | 35 |
| Peanut kernels (efficient | 34 | 16.2 | 9.4 | 40.1 |
| combined nano iron | | | | |
| suspension fertilizer) | | | | |

In Table 2, the control group refers to the foliar spraying of water.

Experiments prove that the efficient combined nano iron suspension fertilizer has a significant effect in both foliar spraying of various crops and the field verification of fertilizer effect. A pear leaf Fe concentration is increased to 236 mg/kg dry weight, which is 1.8 times that of FeSO₄ (133 mg/kg). A pear fruit Fe concentration is increased to 46 mg/kg dry weight, which is 1.4 times that of FeSO₄ (33 mg/kg). A peanut leaf Fe concentration is increased to 632 mg/kg dry weight, which is 1.1 times that of FeSO₄ (601 mg/kg). A peanut kernel Fe concentration is increased to 34 mg/kg dry weight, which is 1.2 times that of FeSO₄ (29 mg/kg).

Finally, it should also be noted that the terms “comprise/comprising”, “include/including” or any other variant thereof, are intended to encompass a non-exclusive inclusion, such that a process, method, article or apparatus comprising a series of elements includes not only those elements, but also other elements not expressly listed, or also include elements inherent to such process, method, article or equipment.

Although preferred embodiments of the present disclosure have been described, those skilled in the art may make additional changes and modifications to these embodiments once they become aware of a basic inventive concept. Therefore, the appended claims are intended to be construed as including the preferred embodiments and all changes and modifications falling within the scope of the present disclosure.

It will be clear that those skilled in the art may make various modifications and variations of the present disclosure without departing from the spirit and scope of the present disclosure. In this way, the present disclosure is intended to encompass such modifications and variations provided that they fall within the scope of the claims and their equivalents.

What is claimed is:

1. An efficient combined nano iron suspension fertilizer, which is prepared from ingredients comprising, in mass percentage:
10.0% to 20.0% of FeSO₄;
0.5% to 2.0% of zero-valent iron nanoparticles (nZVI);
5.0% to 10.0% of magnetic iron oxide nanoparticles (Fe₃O₄-NPs);
30.0% to 50.0% of citric acid;
1.0% to 5.0% of a dispersant 5040;
0.2% to 1.0% of xanthan gum;
1.0% to 5.0% of magnesium aluminum silicate; and
water as a balance.

2. The efficient combined nano iron suspension fertilizer of claim 1, wherein the efficient combined nano iron suspension fertilizer is prepared from the ingredients comprising, in mass percentage:
16.3% of the FeSO₄;
1.0% of the nZVI;
8.3% of Fe₃O₄-NPs;
44.7% of the citric acid;
4.0% of the dispersant 5040;
0.6% of the xanthan gum;
2.0% of the magnesium aluminum silicate; and
water as a balance.

3. The efficient combined nano iron suspension fertilizer of claim 1, wherein the nZVI and the Fe₃O₄-NPs each have an average particle size of 50 nanometers (nm).

4. A method for preparing the efficient combined nano iron suspension fertilizer of claim 1, comprising:
preparing an aqueous FeSO₄ solution; and
adding the nZVI, the Fe₃O₄-NPs, the citric acid, the dispersant 5040, the xanthan gum and the magnesium aluminum silicate to the aqueous FeSO₄ solution, stirring for dissolution, and ultrasonicating for 3 h to obtain the efficient combined nano iron suspension fertilizer.

5. A method for using the efficient combined nano iron suspension fertilizer of claim 1, comprising: diluting the efficient combined nano iron suspension fertilizer by 200 times, and then spraying onto a surface of a leaf of a plant.

6. The method for using the efficient combined nano iron suspension fertilizer of claim 5, wherein the plant includes one selected from the group consisting of a peanut and a pear.

7. The method of claim 4, wherein the efficient combined nano iron suspension fertilizer is prepared from the ingredients comprising, in mass percentage:
16.3% of the FeSO₄;
1.0% of the nZVI;
8.3% of Fe₃O₄-NPs;
44.7% of the citric acid;
4.0% of the dispersant 5040;
0.6% of the xanthan gum;
2.0% of the magnesium aluminum silicate; and
water as a balance.

8. The method of claim 4, wherein the nZVI and the Fe₃O₄-NPs each have an average particle size of 50 nm.

9. The method of claim 5, wherein the efficient combined nano iron suspension fertilizer is prepared from the ingredients comprising, in mass percentage:
16.3% of the FeSO₄;
1.0% of the nZVI;
8.3% of Fe₃O₄-NPs;
44.7% of the citric acid;
4.0% of the dispersant 5040;
0.6% of the xanthan gum;
2.0% of the magnesium aluminum silicate; and
water as a balance.

10. The method of claim 5, wherein said nZVI and said Fe₃O₄-NPs each have an average particle size of 50 nm.
